(19) United States
(12) Patent Application Publication
(10) Pub. No.: US 2011/0087627 A1
(43) Pub. Date: Apr. 14, 2011

(54) USING NEURAL NETWORK CONFIDENCE TO IMPROVE PREDICTION ACCURACY

(75) Inventors: James J. Schmid, Acworth, GA (US); Danni David, Maharashtra (IN)

(73) Assignee: GENERAL ELECTRIC COMPANY, Schenectady, NY (US)

(21) Appl. No.: 12/575,497

(22) Filed: Oct. 8, 2009

(51) Int. Cl. G06N 3/08; G06N 3/02

(52) U.S. Cl. 706/21; 706/25

(57) ABSTRACT

Systems and methods may be provided for generating a prediction using neural networks. The system and methods may include training a plurality of neural networks with training data, calculating an output value for each of the plurality of neural networks based at least in part on input evaluation points, applying a weight to each output value based at least in part on a confidence value for each of the plurality of neural networks; and generating an output result.

### FIELD OF THE INVENTION

This invention generally relates to prediction system and methods, and more particularly to the use of confidence in neural networks to improve prediction accuracy.

### BACKGROUND OF THE INVENTION

Many real-world problems often require some form of prediction, estimation, or “best guess” when only a limited amount of information is available, or when the prediction must be inferred from related information. Weather forecasts exemplify the use of a predictive system, where measurable data, such as temperature, humidity, barometric pressure, and wind speed are combined with historical data to predict the likelihood of inclement weather. Pandemic estimation is another example of a predictive system where infectious disease outbreaks can be predicted based on a combination of data, computational techniques, and epidemiological knowledge. Predictive systems are also often used in engineering, where certain information may be unavailable for direct measurement, and instead, must be inferred from other related variables that are measureable.

In each of the preceding examples, the real-life system may be so complex that it may not be modeled accurately, and therefore, a neural network may be employed to solve the problem at hand. Neural networks may be used to solve real problems without necessarily creating a model of the real system to be solved. In its most basic form, a neural network can mimic the neuron structure of the brain. For example, a neural network includes a group of nodes, interconnected in an adaptive network system that can change its structure based on the information flowing through the network. By altering the strength of certain connections in the network, an outcome may be “learned” for a particular stimulus input, and therefore, such an adaptive network can be very useful for finding patterns in data, and for predicting results based on limited information without prior knowledge about the underlying system to be solved.

Many adaptive systems and algorithms have been proposed for training and using neural networks to solve real world problems, and most are based in optimization theory and statistical estimation. Previous predictive system architecture have averaged the results from multiple, separately trained neural networks in an effort to increase the prediction accuracy, however such systems often require increasing amounts of computer memory, processing power and training. Therefore, alternative systems and methods are still needed for improving prediction accuracy.

### BRIEF DESCRIPTION OF THE INVENTION

Some or all of the above needs may be addressed by certain embodiments of the invention. Certain embodiments of the invention may include systems and methods for using neural network confidence to improve prediction accuracy. Other embodiments can include systems and methods that may further improve prediction accuracy by penalizing the contribution of neural networks that have confidence values below a defined threshold.

According to an exemplary embodiment of the invention, a method for generating a prediction in neural network calculations is provided. The method can include training a plurality of neural networks with training data, calculating an output value for each of the plurality of neural networks based at least in part on input evaluation points, applying a weight to each output value based at least in part on a confidence value for each of the plurality of neural networks, and generating an output result.

According to an exemplary embodiment of the invention, a prediction system is provided. The prediction system can have at least one computer processor operable to train a plurality of neural networks with training data, calculate an output value for each of the plurality of neural networks based at least in part on input evaluation points, apply a weight to each output value based at least in part on a confidence value for each of the plurality of neural networks, and generate an output result.

According to an exemplary embodiment of the invention, another prediction system is provided. The prediction system can have at least one computer processor operable to train a plurality of neural networks with training data, calculate an output value for each of the plurality of neural networks based at least in part on input evaluation points, apply a weight to each output value based at least in part on a confidence value for each of the plurality of neural networks, sum the weighted output values, sum the weights, divide the summed weighted output values by the summed weights, and generate an output result.

Other embodiments and aspects of the invention are described in detail herein and are considered a part of the claimed invention. Other embodiments and aspects can be understood with reference to the description and to the drawings.

### BRIEF DESCRIPTION OF THE FIGURES

FIG. 1 is a block diagram of an example prediction system in accordance with an exemplary embodiment of the invention.

FIG. 2 is a flow chart for an example method of an exemplary embodiment of the invention.

FIG. 3 is a diagram showing example neural network inputs, example calculated outputs, and confidence values for a prediction example in accordance with an exemplary embodiment of the invention.

FIG. 4 is a diagram showing example neural network inputs, example calculated outputs, confidence value, and penalties for an optimization example in accordance with an exemplary embodiment of the invention.

### DETAILED DESCRIPTION OF THE INVENTION

Embodiments of the invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the invention may provide increased accuracy in prediction systems by utilizing multiple neural networks, and by factoring in the result confidence for each neural network. According to example embodiments of the invention, multiple, independently trained neural networks may provide both an output and a confidence value associated with the output in response to inputs. The confidence value may be utilized to further refine an aggregate output from the multiple neural networks.

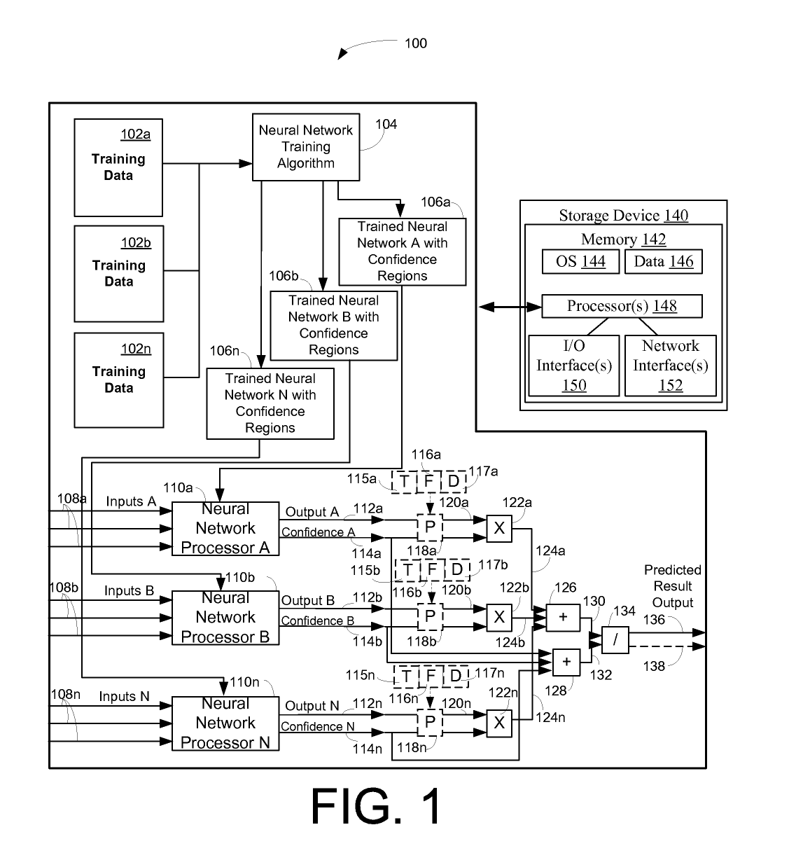

FIG. 1 illustrates an example prediction/optimization system 100 that uses neural network confidence to improve prediction accuracy, according to an embodiment of the invention. In this example embodiment, multiple neural network processes A, B, . . . , N may proceed in parallel, each with corresponding training data (102a, 102b, . . . 102n), trained neural networks (106a, 106b, . . . 106n), input data sets (108a, 108b, . . . 108n), neural network processors (110a, 110b, . . . 110n), outputs (112a, 112b, . . . 112n), confidence values (114a, 114b, . . . 114n), and so forth.

According to an example embodiment of the invention, training data 102a, 102b, . . . 102n may be selected as a random subset of a greater subset of training data. A neural network training algorithm 104 may be utilized to train each of the multiple neural networks A, B . . . N 106a, 106b . . . 106n each with a different set of training data 102a, 102b . . . 102n. According to example embodiments of the invention, the neural network training algorithm 104 may train the neural networks 106a, 106b . . . 106n.

The trained neural networks 106a, 106b . . . 106n may be utilized in neural network processors 110a, 110b . . . 110n to produce output values 112a, 112b . . . 112n and confidence values 114a, 114b . . . 114n in response to data set evaluation point inputs 108a, 108b . . . 108n. According to example embodiments of the invention, the output values 112a, 112b . . . 112n may be multiplied by the corresponding confidence value 114a, 114b . . . 114n via multiplier blocks 122a, 122b . . . 122n, and the resulting products 124a, 124b . . . 124n may be summed by an output summing block 126. The confidence values 114a, 114b . . . 114n may be summed by a confidence summing block 128. Divisor block 134 may divide the aggregate sum of the confidence-scaled output 130 by the aggregate sum of the confidence values 132 to produce a predicted result output 136.

FIG. 1 also depicts an optional example embodiment of the invention wherein penalizing multipliers 118a, 118b . . . 118n may be utilized in optimization calculations by directionally weighting the corresponding output of the neural network processors 110a, 110b . . . 110n based on confidence thresholds 115a, 115b . . . 115n. For example, if any of the confidence values 114a, 114b . . . 114n fall below a defined confidence threshold 115a, 115b . . . 115n, then a penalizing factor 116a, 116b . . . 116n and an optimization direction 117a, 117b . . . 117n may be applied to the output values 112a, 112b . . . 112n to modify the penalized outputs 120a, 120b . . . 120n such that they move in opposition to the optimization direction. Since most optimization problems involve finding a minima or maxima, the optimization direction 117a, 117b . . . 117n may be inferred from the type of optimization problem at hand. For example, if the optimization is attempting to maximize a value (e.g., gas mileage), then the optimization direction 117a, 117b . . . 117n may be negative, and the penalized output 120a, 120b . . . 120n may be less than that of the neural network output 112a, 112b . . . 112n. Conversely, if the optimization problem involved minimizing a value (gas consumption), then the optimization direction 117a, 117b . . . 117n maybe positive, and the penalized output 120a, 120b . . . 120n may be greater than that of the neural network output 112a, 112b . . . 112n. Therefore, according to an example embodiment of the invention, the optimization direction 117a, 117b . . . 117n may be combined with the penalizing factor 116a, 116b . . . 116n to produce the appropriate penalizing multiplier 118a, 118b . . . 118n for scaling the corresponding output values 112a, 112b . . . 112n when the corresponding confidence values 114a, 114b . . . 114n are below confidence thresholds 115a, 115b . . . 115n.

The system of FIG. 1 may include one or more general or special purpose computer processors 148 to carry out the training, processing, I/O and the computations in the prediction system. Alternatively, the training or other sub-blocks of the prediction system may be carried out by other processors. The computer processors 148 may process data 146, and may be in communication with memory 142, an operating system 144, one or more I/O interfaces 150, one or more network interfaces 152, and a data storage device 140.

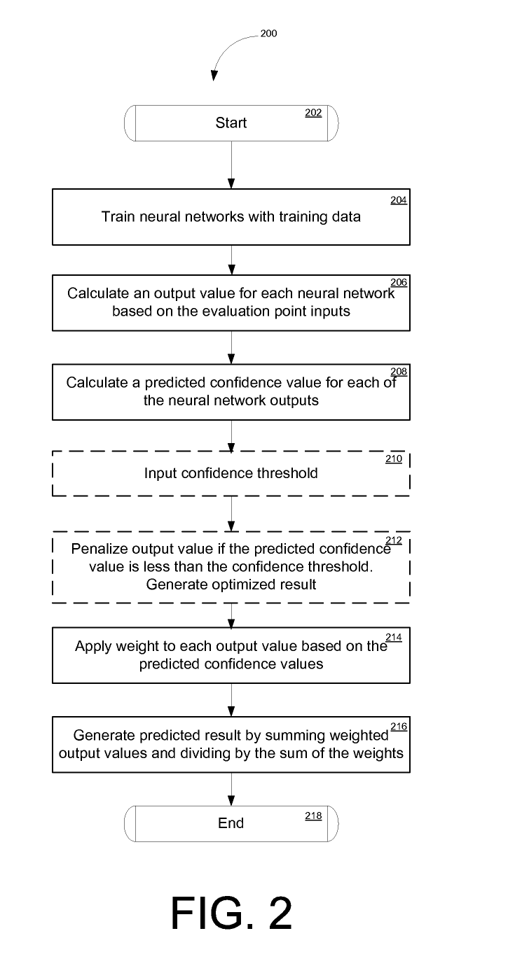

An example method for utilizing neural network confidence information to improve prediction accuracy will now be described with reference to the example method 200 illustrated in the flowchart of FIG. 2. The method 200 begins at block 202. At block 204, multiple neural networks 106a, 106b . . . 106n are trained with different sets of training data 102a, 102b . . . 102n. As indicated above, each set of training data 102a, 102b . . . 102n may be selected as a random subset of a greater subset of training data. The neural network training algorithm 104 may also train each of the neural networks 106a, 106b . . . 106n such that each network can evaluate a confidence value 114a, 114b . . . 114n corresponding to each output 112a, 112b . . . 112n from the neural network processors A, B, . . . N 110a, 110b . . . 110n.

At block 206, each of the multiple neural network processors A, B, . . . N 110a, 110b . . . 110n may calculate an output 112a, 112b . . . 112n based at least in part on data set evaluation point inputs 108a, 108b, . . . 108n. At block 208, each of the multiple neural networks processors A, B, . . . N 110a, 110b . . . 110n may calculate a predicted confidence value 114a, 114b, . . . 114n for each of the neural network outputs 112a, 112b, . . . 112n.

The method 200 can continue to optional block 210 where confidence threshold values 115a, 115b, . . . 115n may be input when the system is used for optimization calculations. Optional block 212 may utilize the confidence threshold values 115a, 115b, . . . 115n, the penalizing factors 116a, 116b . . . 116n, and the optimization directions 117a, 117b, . . . 117n via penalizing multipliers 118a, 118b, . . . 118n to modify or penalize the outputs 112a, 112b, . . . 112n to produced penalized outputs 120a, 120b, . . . 120n if the predicted confidence values 114a, 114b, . . . 114n are less than the confidence threshold values 115a, 115b, . . . 115n. According to an example embodiment of the invention, when the prediction/optimization system 100 is used for optimization problems, an optimized result 138 may be generated or derived from the penalized outputs 120a, 120b, . . . 120n, and one or more of the remaining processes (e.g., 122a 122b, . . . 122n, 126, 128, 134) may not be required. As indicated above, the optional threshold, penalizing factors, and optimization directions provide additional accuracy in optimization problems by constraining the confidence evaluation to preferentially select confident results and penalize the results with lower confidence.

If the prediction/optimization system 100 is utilized for prediction, the method 200 can continue at block 214 where each output values 112a, 112b, . . . 112n may be weighted, or multiplied by the respective predicted confidence values 114a, 114b, . . . 114n. In block 216, a predicted output 136 is generated by summing the confidence-weighted output values 124a, 124b, . . . 124n to produce an aggregate sum of the confidence-scaled output values 130 and dividing the aggregate sum 130 by an aggregate sum of the confidence values 132. The method 200 ends at block 218.

According to example embodiments of the invention, the accuracy of the predicted result output 136 (or optionally, the optimized result output 138) produced by the example prediction/optimization system 100 can be increased by utilizing the neural network confidence values.

An example application will now be described to illustrate how embodiments of the invention may be used to solve certain real-world problems. An embodiment of the invention may be used for predicting the number of miles that a car may continue to travel given the current fuel level in the gas tank. A rough estimate of remaining mileage may be obtained by multiplying the number of remaining gallons of fuel by the average miles-per-gallon rating on the vehicle to arrive at an estimated number of miles the car can travel before running out of gas. But such an estimate does not take into account other considerations, such as the driving conditions (highway, or stop-and-go), the history of the driver (lead-foot or Sunday driver), the current fuel consumption rate, the temperature, whether or not the air-conditioner is on, the load on the vehicle, etc.

According to an example embodiment of the invention, training multiple independent neural networks 106a, 106b, . . . 106n may be achieved by continuously monitoring independent subsets of stored measurement data 102a, 102b, . . . 102n. The vehicle may be equipped with sensors to continuously measure information that might be related to the fuel consumption, for example: engine temperature, air temperature, engine RPM (revolutions per minute), accelerator position, accessory load, vehicle speed, battery voltage, and carbon dioxide emissions. One neural network 106a may be trained using a random subset of the available data 102a, for example, the engine temperature, the battery voltage, and the CO₂ emissions. Another neural network 106b may be trained using a different random subset of the available data 102b, for example, the vehicle speed, the engine RPM, and the engine temperature, and so forth.

The training process may evaluate the correlation of the measured training subset variables with the position of the vehicle to arrive at a confidence value for each of the neural networks to predict the accurate mileage remaining. Then the trained neural networks may receive current data (via evaluation point inputs 108a, 108b, . . . 108n) from the vehicle sensors to produce neural network outputs 112a, 112b, . . . 112n, and associated confidence values 114a, 114b, . . . 114n for further refinement and processing.

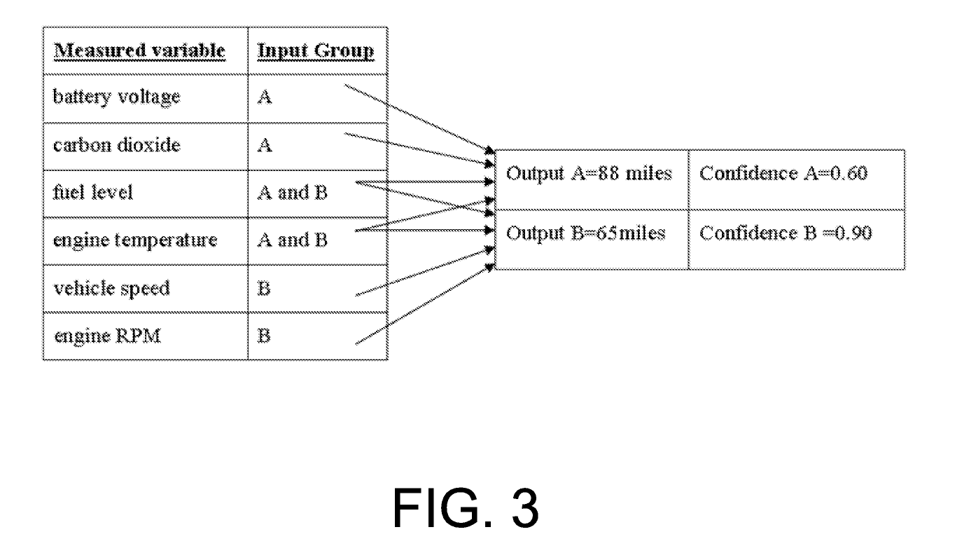

Continuing the vehicle mileage prediction example, and according to example embodiments of the invention, output values 112a, 112b, . . . 112 and confidence values 114a, 114b, . . . 114n calculated by the neural network processors 110a, 110b, . . . 110n may be further processed to increase the prediction accuracy by preferentially weighting results with higher confidence values. It may be illustrative now to demonstrate the prediction refinement using real values for the vehicle example. FIG. 3 indicates example values for the purposes of illustration.

As indicated in FIG. 3, the measured variables, which are used as data set evaluation point inputs 108a, 108b, include two groups for this example. The first group, which is used for inputs 108a into neural network processor A, include (1) battery voltage, (2) carbon dioxide, (3) engine temperature, and (4) fuel level. The second group, which is used for inputs 108b into neural network processor B include (1) fuel level, (2) engine temperature, (3) vehicle speed, and (4) engine RPM. Notice that the fuel level and engine temperature measurements are being utilized as input for both neural networks. Neural networks A and B, at this point, are already assumed to be trained using training data 102a, 102b that corresponds to these measured variables.

FIG. 3 indicates that the neural networks A 110a and B 110b may calculate respective output values 112a, 112b corresponding to the multiple input values 108a, 108b, and a corresponding confidence value 114a, 114b for each output 112a, 112b. In the example above, neural network processor A 110a has calculated that the vehicle can go for another 88 miles before it runs out of gas, but the confidence 114a in this calculation is only about 60%. Whereas, neural network processor B 110b has calculated that the vehicle can go for only 65 miles before it runs out of gas, and the confidence 114b in this calculation is about 90%. These example calculations appear to be reasonable since in input values 108b for neural network processor B 110b include vehicle speed and RPM, which are likely to be more indicative of fuel consumption than the battery voltage or carbon dioxide inputs 108a into neural network processor A 110a.

Previous systems would average the two numbers (88 and 65) together to get a value of about 76.5 for a predicted number of miles left before running out of gas. But according to embodiments of the invention, and as indicated in FIG. 1, the confidence values 114a, 114b are utilized to further refine the neural network output values 112a, 112b from the neural networks A 110a and B 110b. Continuing the above example, the outputs 112a, 112b may be multiplied 122a, 122b by the corresponding confidence values 114a, 114b, and these products 124a, 124b may be summed 126. The resulting sum 130 may be divided 134 by the sum 128 of the confidence values 114a, 114b to produce a predicted result output 136. For example, the process may be illustrated in the following elements using the numbers in the above example:

Element 1: Output A multiplied by confidence A: 88×0.6=52.8,
Output B multiplied by confidence B: 65×0.9=58.5;

Element 2: Sum the scaled values above: 52.8+58.5=111.30

Element 3: Sum the confidence values: 0.6+0.9=1.5

Element 4 Divide value in Element 2 by value in Element 3: 111.30/1.5=74.2

As can be seen in the example above, and based on the numbers provided, the predicted result output 136 of about 74.2 miles left before the vehicle runs out of gas is probably a better estimate than the value (about 76.5) calculated using averages only.

According to an optional embodiment involving penalizing, the invention may be applied to optimization problems to more accurately optimize an outcome. In this optional embodiment, the outputs may be penalized based on confidence thresholds so that outputs with low confidence values may be directionally weighted to move the result in opposition to the optimization direction. In real life cases, there may be variable values and combinations that would be unreasonable, or unrealistic: for example if the goal is to maximize fuel efficiency, a vehicle speed of one mile per hour might contribute to increased gas mileage, but such a slow speed may not be practical. Therefore, according to example embodiments of the invention, confidence values 114a, 114b, . . . 114n that are less than confidence thresholds 115a, 115b, . . . 115n may have penalizing factors 116a, 116b, . . . 116n and optimization directions 117a, 117b, . . . 117n applied to the neural network output values 112a, 112b, . . . 112n via the penalizing multipliers 118a, 118b, . . . 118n to improve the optimized result output 138.

An example illustrating the optimization problem as it relates to embodiments of the invention involves maximizing the gas mileage of a car, (rather than to predict the number of miles left in the tank of gas, as was presented in the prediction example above), using variables such as: engine temperature, air temperature, engine RPM (revolutions per minute), accelerator position, accessory load, vehicle speed, battery voltage, and carbon dioxide emissions. In other words, the goal may be to find the optimum (but reasonable) combination of the variables listed above that will maximize the gas mileage of the car.

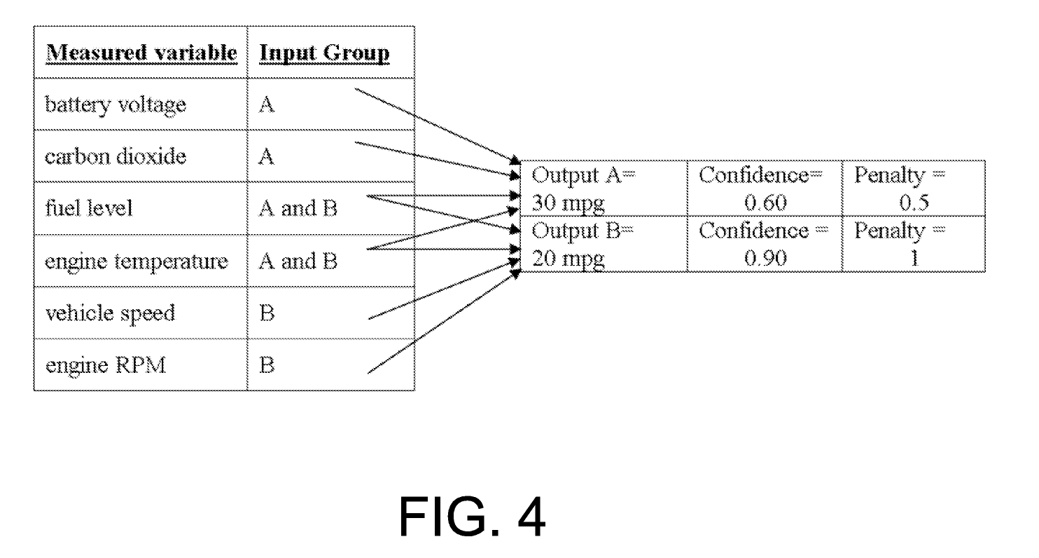

FIG. 4 indicates example mpg (miles per gallon) output values 112a, 112b and corresponding confidence value 114a, 114b that the neural networks A 110a and B 110b may calculate based on the measured variables in two groups. In this example, neural network processor A 110a has calculated a value of 30 mpg, with a confidence of 60% based on battery voltage, carbon dioxide, fuel level and engine temperature. Neural network processor B 110b has calculated a value of 20 mpg, with a confidence of 90% based on the fuel level, engine temperature, vehicle speed, and engine RPM. These example confidence calculations appear to be reasonable since in input values 108b for neural network processor B 110b include vehicle speed and RPM, which are likely to be more indicative miles per gallon than the battery voltage or carbon dioxide inputs 108a into neural network processor A 110a.

If the confidence thresholds 115a 115b in this example are set at 85%, then the penalizing multiplier A 118a may only penalize the neural network output value A 112a since the confidence value A 114a is below 85%, but confidence value B 114b is above 85%. The penalization may be based on the penalizing factor A 116a and the optimization direction A 117a. According to example embodiments, the penalizing factors 116a, 116b, . . . 116n may all be the same, or they may be different, they may represent a percentage, and the values may be arbitrary. The penalizing factors 116a, 116b, . . . 116n may be used in conjunction with the optimizing directions 117a, 117b, . . . 117n to modify the output of a neural network when the confidence is below the designated threshold so that the penalized output is modified to move it in an opposite direction from the optimization problem. For example, if the optimization is attempting to maximize an output, then the penalization may reduce the output. In an example embodiment, the neural network output 112a, 112b, . . . 112n may simply be ignored if the associated confidence value 114a, 114b, . . . 114n is less than the confidence threshold value 115a, 115b, . . . 115n.

In our example above, and as indicated in FIG. 4, the combined penalty would be about 0.5, and therefore, penalizing multiplier A 118a would multiply the neural network output A 112a by 0.5 before further processing. The penalty scaling value of 0.5 may have been arrived at by knowledge that the problem to be optimized was a maximization (mpg) problem. Therefore, any output value with a confidence value less than the confidence threshold would be scaled in a way that would move the scaled output in an opposite direction from the maxima. The example optimization process may be illustrated in the following elements using the numbers in the above example:

Element 1: Output A penalized by 50%: 30 mpg×0.5=15 mpg
Output B not penalized B=20 mpg (confidence is above threshold)

Element 2: If Output A<Output B, select output B (20 mpg).

As can be seen in the example above, and based on the numbers provided, since the penalized output A 120a is less than output B 120b, output B may be selected as the optimal solution for the optimized result output 138. According to example embodiments of the invention, when the prediction/optimization system 100 is utilized for optimization, the optimized result output 138 may be derived from the penalized output 120a, 120b, . . . 120n of the penalizing multipliers 118a, 118b, . . . 118n, and one or more of the remaining processes (e.g., 122a 122b, . . . 122n, 126, 128, 134) may be bypassed. According to example embodiments of the invention, the optimized result output 138 could be improved further with additional tuning of the confidence thresholds 115a, 115b, . . . 115n and penalizing factors 116a, 116b, . . . 116n.

Example embodiments of the invention can provide the technical effects of creating certain systems and methods that provide improved prediction and optimization accuracy. Example embodiments of the invention can provide the further technical effects of providing systems and methods for using neural network confidence to improve prediction and optimization accuracy.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general purpose computer, a special-purpose computer, a processor or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements for implementing the functions specified in the flow diagram block or blocks.

Accordingly, blocks of the block diagrams and flow diagrams support combinations of means for performing the specified functions, combinations of elements for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements, or combinations of special purpose hardware and computer instructions.

In certain embodiments, performing the specified functions, elements can transform an article into another state or thing. For instance, example embodiments of the invention can provide certain systems and methods that transform representative data of measurement data to an inferred or predicted output result.

Many modifications and other embodiments of the invention set forth herein will be apparent having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A method for generating a prediction using neural networks, the method comprising:
training a plurality of neural networks with training data;
calculating an output value for each of the plurality of neural networks based at least in part on input evaluation points;
applying a weight to each output value based at least in part on a confidence value for each of the plurality of neural networks; and
generating an output result.

2. The method of claim 1, wherein the confidence value is based at least in part on a distance from a closest cluster of training data to the output value.

3. The method of claim 1, wherein the training data for training the plurality of neural networks comprises empirical data.

4. The method of claim 1, wherein calculating the output value for each of the plurality of neural networks comprises modifying the output value if the confidence value is less than a confidence threshold value.

5. The method of claim 1, wherein the training data used in training each of a plurality of neural networks comprises a different random subset of a greater set of training data.

6. The method of claim 1, wherein applying a weight to each output value is based at least in part on an interpolated confidence value to increase the accuracy of the output result.

7. The method of claim 1, wherein generating the output result comprises summing weighted output values and dividing by a sum of the weights

8. A prediction system comprising:
at least one processor operable to:
train a plurality of neural networks with training data;
calculate an output value for each of the plurality of neural networks based at least in part on input evaluation points;
apply a weight to each output value based at least in part on a confidence value for each of the plurality of neural networks; and
generate an output result.

9. The system of claim 8, wherein the confidence value is based at least in part on a distance from a closest cluster of training data to the output value.

10. The system of claim 8, wherein the training data comprises empirical data.

11. The system of claim 8, wherein the output value for each of the plurality of neural networks is modified if the confidence value is less than a confidence threshold value.

12. The system of claim 8, wherein the training data comprises a different random subset of a greater set of training data.

13. The system of claim 8, wherein the weight applied to each output value is based at least in part on an interpolated confidence value.

14. The system of claim 8, wherein the output result comprises a sum of the weighted output values divided by a sum of the weights.

15. A prediction system comprising:
at least one processor operable to:
train a plurality of neural networks with training data;
calculate an output value for each of the plurality of neural networks based at least in part on input evaluation points;
apply a weight to each output value based at least in part on a confidence value for each of the plurality of neural networks;
sum the weighted output values;
sum the weights;
divide the summed weighted output values by the summed weights; and
generate an output result.

16. The system of claim 15, wherein the confidence value is based at least in part on a distance from a closest cluster of training data to the output value.

17. The system of claim 15, wherein the output value for each of the plurality of neural networks is modified if the confidence value is less than a confidence threshold value.

18. The system of claim 15, wherein the training data comprises a different random subset of a greater set of training data.

19. The system of claim 15, wherein the weight applied to each output value is based at least in part on an interpolated confidence value.

20. The system of claim 15, wherein the output result comprises a sum of the weighted output values divided by a sum of the weights.
